(19) United States
(12) Patent Application Publication
(10) Pub. No.: US 2010/0003143 A1
(43) Pub. Date: Jan. 7, 2010

(54) MICRO-FLUIDIC SYSTEM

(75) Inventors: Jacob Marinus Jan Den Toonder, Eindhoven (NL); Lucas Van Rijsewijk, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/373,739

(22) PCT Filed: Jul. 16, 2007
(86) PCT No.: PCT/IB07/52830

§ 371 Date: Jan. 14, 2009

(30) Foreign Application Priority Data
Jul. 17, 2006 (EP) 06117290.4

(51) Int. Cl. F04B 17/00; F04D 33/00; B23P 15/00; B05D 3/00

(52) U.S. Cl. 417/53; 417/410.1; 29/888.02; 427/130

(57) ABSTRACT

The present invention provides a micro-fluidic system, a method of manufacturing the micro-fluidic system and a method of controlling or manipulating a fluid flow through micro-channels of such a micro-fluidic system. The inner side of the wall of the micro-channel is provided with actuator elements. The actuator elements have composite structures. These actuator elements can change shape and orientation in response to an external stimulus. Through this change of shape and orientation, the flow of a fluid through a micro-channel may be controlled and manipulated.

### FIELD OF THE INVENTION

The present invention relates to a micro-fluidic system, to a method of manufacturing such a micro-fluidic system and to a method of controlling or manipulating a fluid flow through micro-channels of such a micro-fluidic system.

### BACKGROUND TO THE INVENTION

Micro-fluidic systems are becoming a key foundation to many of today's fast-growing biotechnologies, such as rapid DNA separation and sizing, cell manipulation, cell sorting and molecule detection. Micro-fluidic chip-based technologies offer many advantages over their traditional macro-sized counterparts.

In all micro-fluidic devices, there is a basic need for controlling the fluid flow, that is, fluids must be transported, mixed, separated and directed through a micro-channel system consisting of channels with a typical width of about 0.1 mm. A challenge in micro-fluidic actuation is to design a compact and reliable micro-fluidic system for regulating or manipulating the flow of complex fluids of variable composition, e.g. saliva and full blood, in micro-channels. Various actuation mechanisms have been developed and are at present used, such as, for example, pressure-driven schemes, micro-fabricated mechanical valves and pumps, inkjet-type pumps, electro-kinetically controlled flows, and surface-acoustic waves.

In US 2003/0231967, a micro-pump assembly is provided for use in a micro-gas chromatograph and the like, for driving a gas through the chromatograph. This is an example of a membrane-displacement pump, wherein deflection of micro-fabricated membranes provides the pressure for pumping the liquids. A disadvantage, however, of using such micro-pump assembly and of using micro-pumps in general, is that they have to be, in some way, integrated into micro-fluidic systems. This means that the size of the micro-fluidic systems will increase. It would therefore be useful to have a micro-fluidic system which is compact and cheap, and nevertheless easy to process.

It is an object of the present invention to provide an improved micro-fluidic system and a method of manufacturing and operating same. Advantages of the present invention can be at least one of being compact, cheap and easy to process.

The above objective is accomplished by a method and device according to the present invention.

### SUMMARY OF THE INVENTION

In a first aspect, the present invention provides a micro-fluidic system comprising at least one micro-channel having a wall with an inner side, wherein the micro-fluidic system furthermore comprises:

a plurality of actuator elements attached to the inner side of the wall, each actuator element having a shape, an orientation and a composite structure; and

means for applying stimuli to the plurality of actuator elements so as to cause a change in their shape and/or orientation.

Application of stimuli to the plurality of actuator elements provides a way to locally manipulate the flow of complex fluids in a micro-fluidic system. The actuator elements may be driven or addressed individually or in groups to achieve specific ways of fluid flow. The composite structure of the actuator elements ensures that the stimuli needed to actuate the actuator elements can be achieved in practice.

In a preferred embodiment according to the present invention, the composite structure of the actuator elements includes at least a first part and at least a second part wherein the first part has an elastic modulus that is at least a hundred times lower than the second part, preferably a hundred to a thousand times lower. The first part preferably has an elastic modulus in the range of about 1 kPa-100 Mpa, whereas the second part preferably has an elastic modulus in the range of about 1 GPa-200 GPa. In other words, it can be said that the first part is more compliant than the second part. This composite structure on the whole reduces the compliance of the actuator elements compared to the conventional structures that include only one part. Unless the compliance of the actuator element is low, the stimuli required to overcome the stiffness of the actuator elements and to significantly deform them, may become unacceptably large.

In a preferred embodiment according to the present invention, the first part with lower elastic modulus i.e., the compliant part is attached to the inner side of the wall. If the compliant part is attached to the inner side of the wall, the stimuli required to cause a change in the orientation of the actuator elements will be orders of magnitude lower than otherwise.

In a highly preferred embodiment according to the present invention, the first part comprises an elastomer or a polymer gel. The second part comprises a polymer-based material or a metal. The second part preferably comprises a magnetic monolithic or a composite material. Polymer materials are generally tough instead of brittle, relatively cheap, elastic up to large strains (up to 10% or more) and offer a perspective of being processable on large surface areas with simple processes.

In a specific embodiment according to the present invention, the micro-fluidic system comprises a means for applying stimuli to the plurality of actuator elements. The means for applying a stimulus to the plurality of actuator elements is selected from the group comprising an electric field generating means (e.g. a current source or an electrical potential source), an electromagnetic field generating means (e.g. a light source), an electromagnetic radiation means (e.g. a light source), an external or internal magnetic field generating means.

In a most preferred embodiment according to the present invention, the means for applying a stimulus to the actuator elements is a magnetic field generating means.

In one embodiment according to the invention, the plurality of actuator elements may be arranged in a first and a second row, the first row of actuator elements being positioned at a first position of the inner side of the wall and the second row of actuator elements being positioned at a second position of the inner side of the wall, the first position and the second position being substantially opposite to each other.

In another embodiment of the present invention, the plurality of actuator elements may be arranged in a plurality of rows of actuator elements which are arranged to form a two-dimensional array.

In a further embodiment of the present invention, the plurality of actuator elements may be randomly arranged on the inner side of the wall of a micro-channel.

In a second aspect according to the present invention, a method of manufacturing of a micro-fluidic system comprising at least one micro-channel is provided. The method comprises:

providing an inner side of a wall of at least one micro-channel with a plurality of actuator elements with a composite structure; and

providing means for applying a stimulus to said plurality of actuator elements.

A method of providing the plurality of actuator elements with the composite structure is performed by:

spin-coating a low-modulus polymer having a length L₁ on the inner side of the wall to form a first part;

spin-coating a magnetic polymer-based material having a length of L₂ on top of the first part to form a second part; and

structuring the coatings by ion beam lithography to form the composite structure.

Another method of providing the plurality of actuator elements with composite structure is performed by:

depositing and patterning a sacrificial layer on the inner side of the wall;
spin-coating and structuring a magnetic polymer-based material to form the second part of the composite structure;
spin-coating and structuring a compliant polymer material to form the first part of the composite structure; and
removing said sacrificial layer by etching to form the composite structure.

Yet another method of providing the plurality of actuator elements with composite structure is performed by:

surface energy patterning of the inner side of the wall;
spin-coating and structuring a magnetic polymer-based material to form the second part of the composite structure;
spin-coating and structuring a low-modulus polymer material to form the first part of the composite structure; and
applying a driving force to partially release the polymer materials from the inner side of the wall to form the composite structure.

According to preferred embodiments of the invention, the method may furthermore comprise providing the second part of the composite structure of the actuator elements with a uniform continuous magnetic layer or a patterned magnetic layer or with magnetic particles. The means for applying a stimulus to the actuator elements may include providing a magnetic field generating means.

In a further aspect of the present invention, a method of controlling a fluid flow through a micro-channel of a micro-fluidic system is provided. The micro-channel has a wall with an inner side. The method comprises:

providing the inner side of the wall with a plurality of actuator elements, the actuator elements each having a shape, an orientation and a composite structure; and

applying a stimulus to the actuator elements so as to cause a change in their shape and/or orientation.

In a specific embodiment according to the invention, applying a stimulus to the actuator elements may be performed by applying a magnetic field.

The present invention also includes, in a further aspect, a micro-fluidic system comprising at least one micro-channel having a wall with an inner side and containing a liquid, wherein the micro-fluidic system furthermore comprises:

a plurality of actuator elements attached to the inner side of the wall; and

means for applying stimuli to the plurality of actuator elements so as to drive the liquid in a direction along the micro-channel.

The micro-fluidic system according to the invention may be used in biotechnological, pharmaceutical, electrical or electronic applications. In biotechnological applications the micro-fluidic system is used in biosensors, in rapid DNA separation and sizing, in cell manipulation and sorting. In pharmaceutical applications, the micro-fluidic system is used in high-throughput combinatorial testing where local mixing is essential. In electrical or electronic applications, the micro-fluidic system is used in micro-channel cooling systems.

The micro-fluidic system according to the invention may be used in a diagnostic device such as a biosensor for the detection of at least one target molecule, such as proteins, antibodies, nucleic acids (e.g. DNA, RNA), peptides, oligo- or polysaccharides or sugars, in biological fluids, such as saliva, sputum, blood, blood plasma, interstitial fluid or urine.

### BRIEF DESCRIPTION OF THE FIGURES

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 illustrates a prior art micro-pump assembly;

FIG. 2a is a schematic representation of a composite structure for a beam-shaped actuator;

FIG. 2b is a schematic representation of a composite structure for a rod shaped actuator element;

FIG. 2c is a schematic representation of a composite structure with a low-modulus foundation for a beam-shaped actuator;

FIG. 3a illustrates a step of applying and curing a low-modulus polymer on an inner side of a wall of a micro-channel by spin-coating according to an embodiment of the invention;

FIG. 3b illustrates a step of applying and curing a magnetic polymer on the low-modulus polymer by spin-coating according to an embodiment of the invention;

FIG. 3c illustrates a step of structuring the layers by ion beam lithography according to an embodiment of the invention;

FIG. 4a illustrates a step of applying an ITO layer on an inner side of a wall of a micro-channel according to another embodiment of the invention;

FIG. 4b illustrates a step of structuring the ITO layer by etching according to another embodiment of the invention;

FIG. 4c illustrates a step of depositing a dielectric layer according to another embodiment of the invention;

FIG. 4d illustrates a step of depositing a sacrificial layer according to another embodiment of the invention;

FIG. 4e illustrates a step of patterning the sacrificial layer according to another embodiment of the invention;

FIG. 4f illustrates a step of depositing a magnetic layer according to another embodiment of the invention;

FIG. 4g illustrates a step of applying a magnetic polymer layer by spin-coating according to another embodiment of the invention;

FIG. 4h illustrates a step of patterning and curing of the magnetic polymer layer according to another embodiment of the invention;

FIG. 4i illustrates a step of applying a low-modulus polymer layer by spin-coating according to another embodiment of the invention;

FIG. 4j illustrates a step of patterning and curing the low-modulus polymer layer according to another embodiment of the invention;

FIG. 4k illustrates a step of etching the magnetic layer according to another embodiment of the invention;

FIG. 4l illustrates a step of etching the sacrificial layer according to another embodiment of the invention;

FIG. 5 is a schematic illustration of cross-sections of a micro-channel having the inner side of its wall covered with straight actuator elements according to an embodiment of the invention;

FIG. 6 is a schematic illustration of cross-sections of a micro-channel having the inner side of its wall covered with actuator elements that curl up and straighten out according to another embodiment of the invention;

FIG. 7 is a schematic illustration of cross-sections of a micro-channel having the inner side of its wall covered with actuator elements that move back and forth asymmetrically according to still another embodiment of the invention;

FIG. 8 illustrates the application of a uniform magnetic field on a straight actuator element, according to an embodiment of the present invention;

FIG. 9 illustrates the application of a rotating magnetic field to individual actuator elements, according to a further embodiment of the present invention; and

FIG. 10 illustrates the application of a non-uniform magnetic field using a conductive line to apply a force on an actuator element according to a further embodiment of the present invention.

In the different figures, identical reference signs refer to identical or analogous elements.

### DETAILED DESCRIPTION OF THE INVENTION

Particular and preferred aspects of the invention are set out in the accompanying independent and dependent claims. Features of the dependent claims may be combined with features of the independent claims and with features of other dependent claims as appropriate and not merely as explicitly set out in the claims.

The present invention will be described with respect to particular embodiments and with reference to certain drawings, the invention, however, is not limited thereto, but only by the claims. Any reference signs in the claims shall not be construed as limiting the scope. The drawings described are only schematic and are non-limiting. In the drawings, the size of some of the elements may be exaggerated and not drawn to scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Hereinafter, the term shape means the shape of an actuator element that may be of a beam or of a rod or any other suitable shape including an elongated shape. The term orientation means the orientation of an actuator element that may be perpendicular to or in plane with the inner side of the wall of the micro-channel. The term composite structure means a structure that includes two or more distinct constituent materials. The term compliant polymer is the polymer that has an elastic modulus in the range of about 1 KPa to 100 MPa. Magnetic polymer is the polymer that includes either a uniform or a patterned layer of magnetic material or contains magnetic particles.

In a first aspect, the present invention provides a micro-fluidic system provided with means which allow transportation or (local) mixing or directing of fluids through micro-channels of the micro-fluidic system. In a second aspect, the present invention provides a method for the manufacturing of such a micro-fluidic system. In a third aspect, the present invention provides a method for the control of fluid flow through micro-channels of a micro-fluidic system. The micro-fluidic systems according to the invention are economical and simple to process, while also being robust and compact and suitable for very complex fluids.

A micro-fluidic system according to the invention comprises at least one micro-channel and micro-fluidic elements integrated on an inner side of a wall of the at least one micro-channel. The micro-fluidic elements are the actuator elements. These elements are preferably compliant and tough. The actuator elements preferably respond to a certain stimulus such as an electric field, a magnetic field, etc. by bending or rotating or changing shape. The actuator elements are preferably easy to process by means of relatively cheap processes.

According to the invention, all suitable materials, i.e. materials that are able to change shape by, for example, mechanically deforming as a response to an external stimulus, may be used. The external stimulus may be of varying origin, such as an electric field, a magnetic field, light, temperature, chemical environment, etc. An overview of possible materials is given in Dirk J. Broer, Henk van Houten, Martin Ouwerkerk, Jaap M. J. den Toonder, Paul van der Sluis, Stephen I. Klink, Rifat A. M. Hikmet, Ruud Balkenende. Smart Materials. Chapter 4 in True Visions: Tales on the Realization of Ambient Intelligence, edited by Emile Aarts and José Encarnaçao, Springer Verlag, 2006. Polymer materials are, generally, tough instead of brittle, relatively cheap; elastic up to large strains (up to 10% or more) and offer perspective of being processable on large surface areas with simple processes.

The micro-fluidic system according to the invention may be used in biotechnological applications, such as micro total analysis systems, micro-fluidic diagnostics, micro-factories and chemical or biochemical micro-plants, biosensors, rapid DNA separation and sizing, cell manipulation and sorting, in pharmaceutical applications, in particular high-throughput combinatorial testing where local mixing is essential, and in micro-channel cooling systems e.g. in micro-electronics applications.

The present invention manipulates the fluid motion in micro-channels by covering the walls of the micro-channels with microscopic polymer actuator elements, i.e. polymer structures changing their shape and/or dimension in response to a certain external stimulus. In the following description, these microscopic actuator elements such as polymer actuator elements may also be referred to as actuators, e.g. polymer actuators or micro-polymer actuators, actuator elements, micro-polymer actuator elements or actuator elements. It has to be noticed that when any of these terms is used in the further description always the same microscopic actuator elements according to the invention are meant. The micro-polymer actuator elements or polymer actuators can be set in motion, either individually or in groups, by any suitable external stimuli. These external stimuli may be an electric field such as e.g. a current, a magnetic field, or any other suitable means.

However, for biomedical applications electric and magnetic actuation means may be preferred, considering possible interactions with the complex biological fluids that may occur using other materials to form the actuator elements.

In the description, mainly magnetic actuation will be discussed. An individual magnetically actuated actuator element is basically a flap that is either paramagnetic or ferromagnetic. This can be achieved by incorporating super paramagnetic or ferromagnetic particles in the flap, or depositing a (structured) magnetic layer on the flap, or using intrinsically magnetic polymer materials. The flap can be moved in a magnetic field, either by an effectively applied torque, or by a direct translational force. The field may be either uniform or a spatially varying one which is, for example, induced by a current wire.

The application of an external magnetic field will result in translational as well as rotational forces on the flap. The translational force equals:

\vec{F}=∇(\vec{m}·\vec{B}), (1)

where \vec{m} is the magnetic moment of the flap and \vec{B} is the magnetic induction.

The rotational force, i.e. the torque on the flap, will cause it to move, i.e. rotate and/or change shape. Assuming a magnetic moment of the flap of \vec{m} and a magnetic field strength of \vec{H}, the torque \vec{τ} is given by:

\vec{τ}=μ\vec{m}×\vec{H}=\vec{m}×\vec{B}=V\vec{M}×\vec{B}=Lwt\vec{M}×\vec{B} (2)

where μ is the permeability, \vec{B} is the magnetic induction, \vec{M} is the magnetization (i.e. the magnetic moment per unit volume), and V is the volume of the flap. The flap has dimensions length×width×thickness of L×w×t. The applied torque depends on the angle between the magnetic moment and the magnetic field, and is zero when these are aligned.

To get an effective element for use in a micro-fluidic device, the resulting force acting on the flap must be sufficient to deform the flap significantly (i.e. overcome the stiffness of the flap), and, on the other hand, it must be large enough to exceed the drag acting upon the flap by the surrounding fluid.

In a magnetic field, the flap will experience a torque given by equation (2), which is:

τ=LwtMB sin α (3)

where M is the magnetization of the flap which is assumed to be oriented in the length-direction of the flap. B is the magnitude of the applied magnetic induction, and α is the angle between the magnetization and the applied magnetic field. The torque can be represented as a force F acting on the tip of the flap, by the equation:

$$F = \frac{τ}{L} = wtMB sin α \qquad ( 4 )$$

If the material has a Young's modulus E, the deflection δ of its tip when a load F is acting on it is given by:

$$δ = \frac{4 {L}^{3} F}{E {wt}^{3}} \qquad ( 5 )$$

This formula is valid for fairly small deflections, i.e. in the order of the thickness of the element. For larger deflections needed for an effective fluid actuation, non-linear effects that are not included in equation (5) need to be taken care of. Finite Element Method (FEM) as implemented in the FEM package “Ansys” is used to compute the force-deflection relation.

A typical force needed to deflect the flap by about 5 μm, would be approximately 0.1 μN when E=2 GPa, L=20 μm, w=10 μm, and t=300 nm. The required magnetic field to get this force is estimated from equation (4). It is assumed that the structure is filled with 10 vol % ferromagnetic magnetite particles. The magnetization of bulk magnetite is about 5×10⁵ A/m. Since the particles are spherical, the effective magnetization must be multiplied by a shape factor equal to ⅓. Hence, the effective magnetization of the flap equals M=10%×(⅓)×5×10⁵=1.65×10⁴ A/m. Substituting values in equation (4), and assuming the optimal orientation of the flap, i.e. perpendicular to the magnetic field, it follows that for a force of 0.1 μN a magnetic induction of 2 T is needed. This is an unrealistically large value for practical applications.

When using the magnetic field gradient, and hence the translational force given by equation (1) in combination with a super paramagnetic flap, a similar argument applies. Unless the compliance of the flaps is low, the field gradients/electric current required to overcome the stiffness of the flaps and to significantly deform them, become unacceptably large.

The conventional structures are often too stiff to be actuated with magnetic field(s) (gradients) that can be achieved in practice. Hence special compliant materials or composite structures for the polymer flaps are preferably used to reduce magnetic fields and/or magnetic field gradients.

One way to impart compliance is to use materials with low elastic modulus. Using rubber-like or elastomeric materials such as Poly dimethyl siloxane (PDMS), or other polymers with a glass transition temperature far below room temperature, elastic modulus as low as 1 MPa can be achieved. This is three orders of magnitude lower than the elastic modulus of polymer materials, which are more conventionally used in micro-systems. The elastic modulus of conventional polymer materials is around 2 GPa. As an alternative, polymer gels may also be used, and these may have elastic modulus as low as 10 kPa, five orders of magnitude lower than that for the conventional materials. This means that, according to equation (5), the deflection at a given force (and hence magnetic field, if the magnetic properties of the material are preserved) can be increased by orders of magnitude. For any given deflection, the required magnetic field is proportional to the elastic modulus.

According to one embodiment, the actuator element is made of an elastomer or a polymer gel. Typical materials are PDMS, poly-urethanes, poly-acrylamide and the like. Typical range of elastic moduli is between 1 kPa (for gels) and 100 MPa (for elastomers). The magnetic properties are achieved by incorporating super paramagnetic or ferromagnetic particles in the flap, or depositing a structured magnetic layer on the flap. The configuration of the structure may be perpendicular to the surface, or it may be parallel to the surface initially, to which it is attached at one end, and forced to curl upwards due to the magnetic field.

According to another embodiment, the actuator element has a composite structure including at least a first part and at least a second part. The first part has an elastic modulus which is at least a hundred times lower than the second part. The first part is attached to the inner side of the wall of the micro channel. The first part consists of an elastomeric material or a polymer gel, with a typical range of elastic moduli between 1 kPa (for gels) and 100 MPa (for elastomers). To be able to actuate the actuator elements by applying a magnetic field, the actuator elements must be provided with magnetic properties. These properties are achieved by incorporating super paramagnetic or ferromagnetic particles in or depositing a uniform continuous magnetic layer or a patterned magnetic layer on the second part of the composite structure of the actuator element. The orientation of the actuator element can be perpendicular to or in plane with the inner side of the wall of the micro-channel. The actuator elements may have any shape such as a rod, a beam and/or of any elongated shape.

According to another embodiment, the actuator element is placed on a foundation comprising low-modulus material, such as an elastomer or a polymer gel.

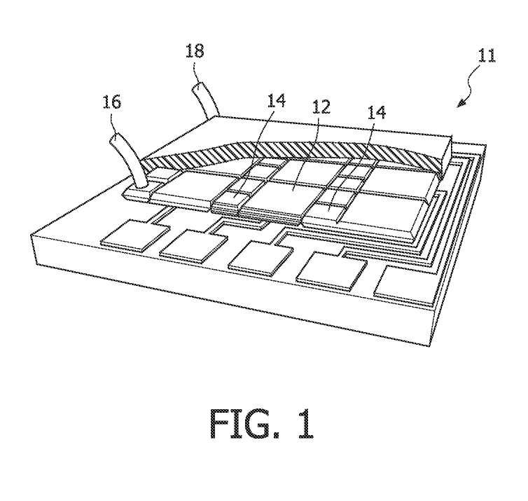

FIG. 1 illustrates a prior art micro-pump assembly. A micro-pump assembly 11 is provided for use in a micro-gas chromatograph and the like, for driving a gas through the chromatograph. The micro-pump assembly 11 includes a micro-pump 12 having a series arrangement of micro machined pump cavities, connected by micro-valves 14. A shared pumping membrane divides the cavity into top and bottom pumping chambers. Both pumping chambers are driven by the shared pumping membrane, which may be a polymer film. Movement of the pumping membrane and control of the shared micro-valve are synchronized to control flow of fluid through the pump unit pair in response to a plurality of electrical signals.

The assembly 11 furthermore comprises an inlet tube 16 and an outlet tube 18. Pumping operation is thus triggered electrostatically by pulling down pump and valve membranes in a certain cycle. Through scheduling the electrical signal in a specific way, one can send gas in one direction or reverse. The frequency at which the pump system is driven determines the flow rate of the pump. By having electrodes on both sides, an electrostatically driven membrane easily overcomes mechanical limitations of vibration and damping from resistant air movement throughout holes and cavities.

The micro-pump assembly 11 of US 2003/0231967 is an example of a membrane-displacement pump, wherein deflection of micro-fabricated membranes provides the pressure work for the pumping of liquids.

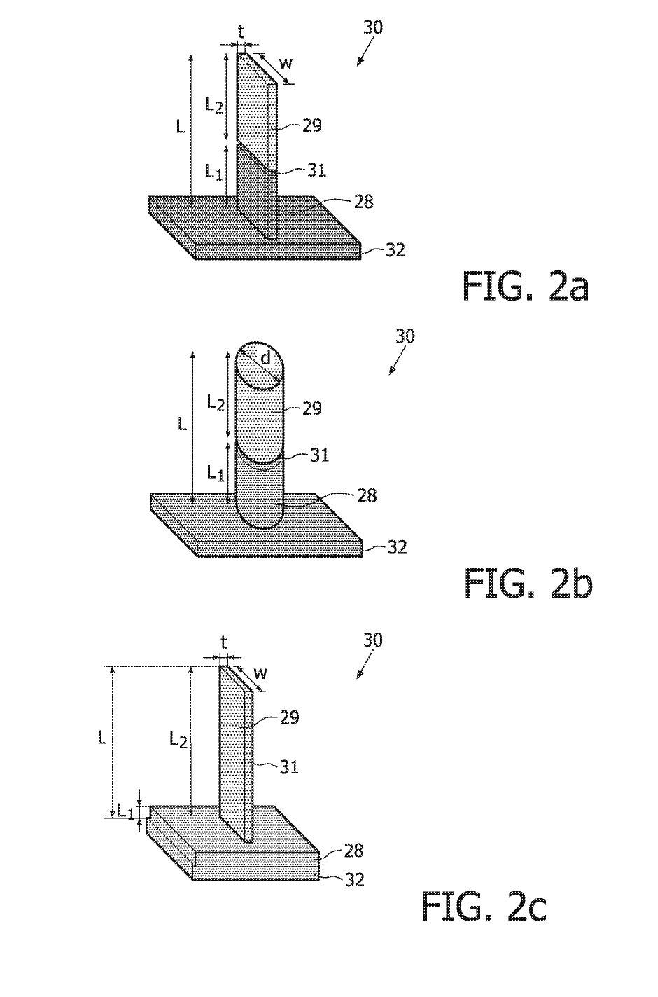

FIG. 2a to FIG. 2c illustrate an example of an actuator element 30 with a composite structure according to an embodiment of the present invention. These figures represent an actuator element 30 which may respond to an external stimulus, such as an electric or magnetic field or any other stimulus, by bending up and down. The polymer actuator element 30 comprises a polymer Micro-Electro-Mechanical System (polymer MEMS) 31 and an attachment means 32 for attaching the polymer MEMS 31 to a micro-channel 33 of the micro-fluidic system. The attachment means 32 can be positioned at a first extremity of the polymer MEMS 31. The polymer MEMS 31 may have the shape of a beam or a rod. However, the invention is not limited to beam or rod-shaped MEMS. The polymer actuator element 30 may also comprise polymer MEMS 31 having other suitable shapes, preferably elongate shapes. The polymer MEMS 31 may comprise two or more parts to enhance the compliance of the actuator element 30. Though the examples in the FIGS. 2a-2c show a polymer MEMS 31 comprising two parts 28 and 29, the invention is not limited to two parts. The first part 28 that is attached to the inner side 35 of the wall 36 of a micro-channel 33 has a lower elastic modulus than the second part 29. The first part 28 includes an elastomeric material or a polymer gel, with an elastic modulus in the range of 1 kPa (for gels) to 100 MPa (for elastomers). The magnetic properties are assigned to the second part 29 by dispersing magnetic particles in the polymer material. These can be super paramagnetic nano-particles e.g. iron oxide particles with a diameter less than 20 nm, or permanent magnetic particles e.g. larger iron oxide particles with a diameter larger than 50 nm. Another way to assign the magnetic properties to the second part is to deposit a magnetic layer on top of or under the polymer layer. The magnetic layer can be any magnetic material, e.g. nickel-iron or cobalt-alloys. The magnetic layer can be a uniform continuous layer or a patterned layer.

According to the above described aspect of the invention, the polymer MEMS 31 may have a length ‘1’ in the range of about 10 to 100 μm, typically 20 μm. They may have a width ‘w’ in the range of about 2 to 30 μm, typically 10 μm. The polymer MEMS 31 may have a thickness ‘t’ in the range of about 0.1 to 2 μm, typically 0.3 μm. The length of the first part 28 may be in the range of about 3 to 30 μm, typically 6 μm.

FIG. 2c sketches another embodiment to illustrate the composite structure of the polymer actuator 30. Here, the first part 28 of the composite structure forms a foundation to which the second part 29 is attached. The thickness of the foundation may be in the range of about 1 to 5 μm, typically 2 μm.

Although, in FIG. 2a to FIG. 2c, an orientation perpendicular to the inner side of the wall of the micro-channel is sketched, the initial orientation may also be in plane with the inner side of the wall of the micro-channel.

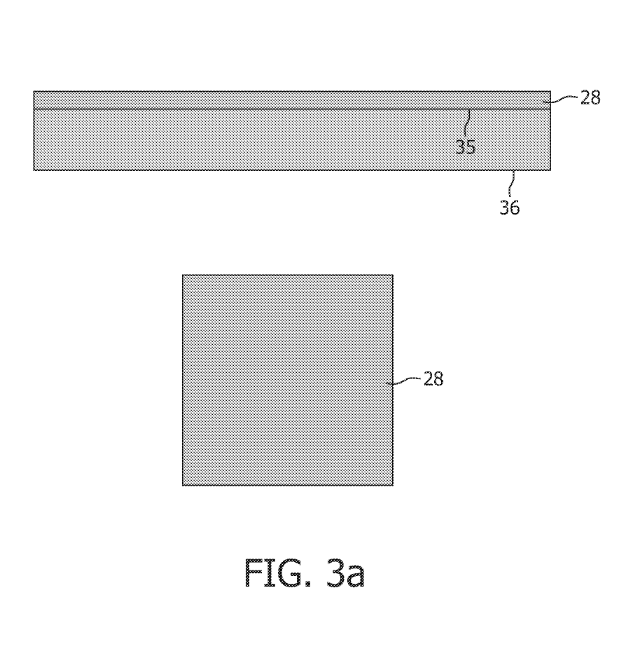

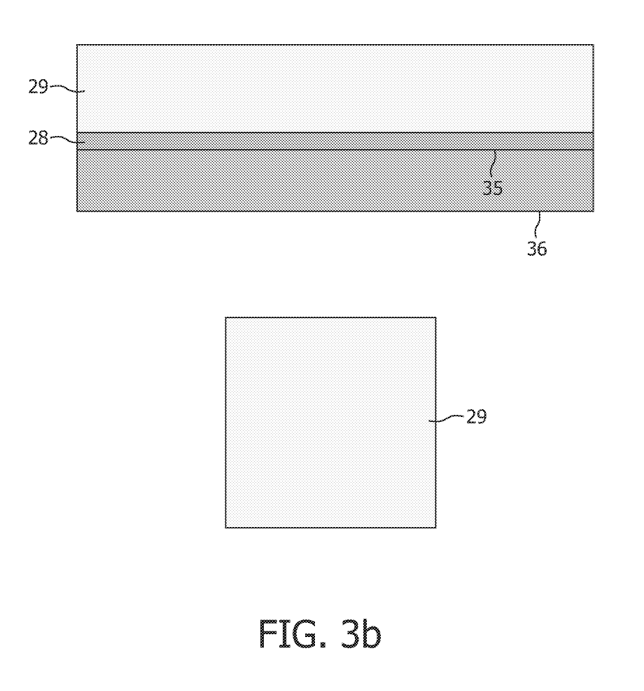

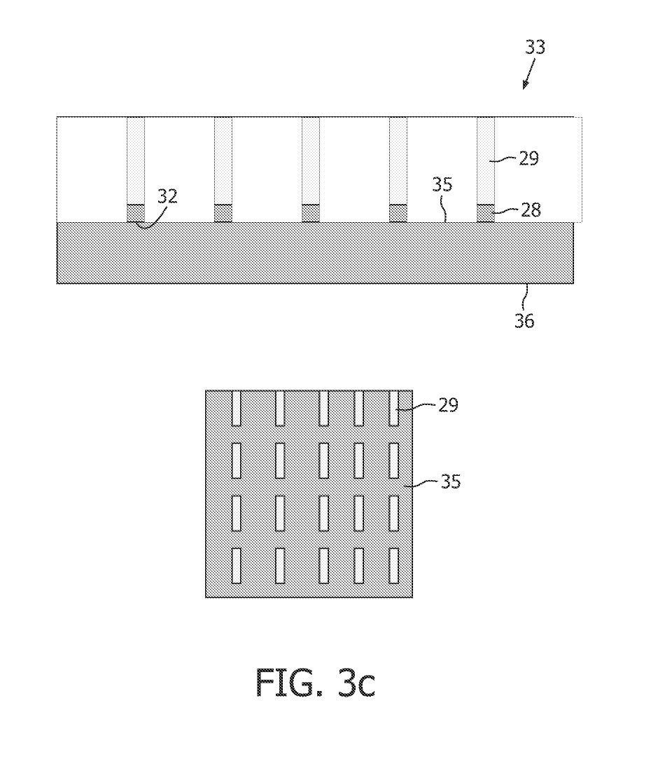

An embodiment depicting the formation of an actuator element 30, comprising a composite structure and is attached to a micro-channel 33, according to the invention, is shown in FIG. 3a to FIG. 3c. The figures shown at the bottom in FIG. 3a to FIG. 3c illustrate another view but not drawn to scale.

The composite structure is obtained by a two-step deposition process. First, the low-modulus polymer material is deposited (e.g. using spin-coating) on the inner side 35 of the wall 36 of a micro-channel 33 and cured to form the first part 28 of the composite structure of the actuator element as shown in FIG. 3a. Subsequently, the magnetic polymer material is deposited (e.g. using spin-coating) over the first part 28 to form the second part 29 as shown in FIG. 3b. To be able to actuate the actuator elements 30 by applying a magnetic field, the actuator elements 30 must be provided with magnetic properties. One way to provide a polymer actuator element 30 with magnetic properties is by incorporating a continuous magnetic layer in the second part of composite structure of the actuator element 30. The continuous magnetic layer may be positioned at the top or at the bottom of the second part of the actuator element 30. The continuous magnetic layer may be an electroplated permalloy (e.g. Ni—Fe) and may be deposited as a uniform layer. The continuous magnetic layer may have a thickness of between 0.1 and 10 μm. Another way to achieve a magnetic actuator element 30 is by incorporating magnetic particles in the polymer actuator element 30. The polymer may in that case function as a ‘matrix’ in which the magnetic particles are dispersed. The magnetic particles may be added to the polymer in solution or may be added to monomers that, later on, then can be polymerized. The magnetic particles may, for example, be ferro- or ferri-magnetic particles, or (super) paramagnetic particles, comprising elements such as cobalt, nickel, iron, ferrites.

After this two-way deposition, the structure is patterned by ion beam lithography (IBL), leaving the desired geometries that form the actuator elements 30 as shown in FIG. 3c. In ion beam lithography (IBL), an ion beam is scanned over the layer in a scan pattern that describes the desired eventual actuator element geometry. The material is removed in the scanned areas and the desired structure remains. The low-modulus polymer layer remaining attached to the inner side (35) of the wall (36) forms the attachment means 32.

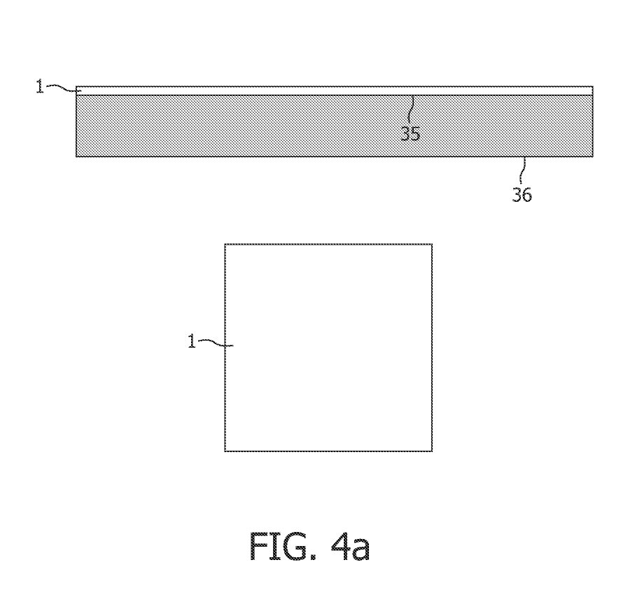

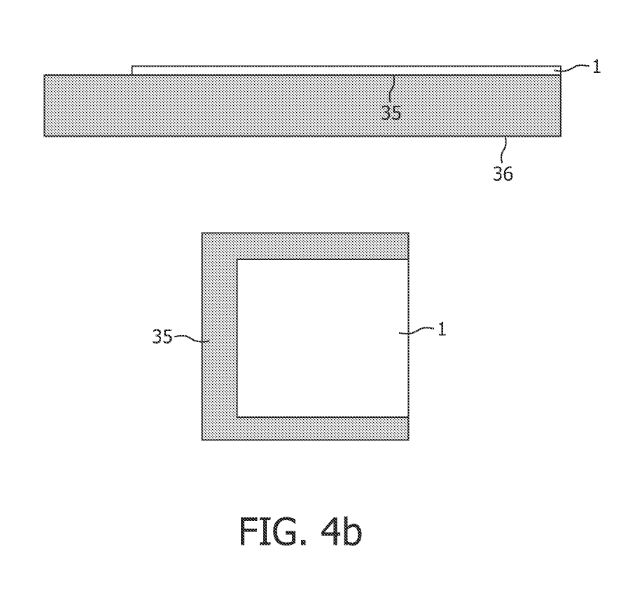

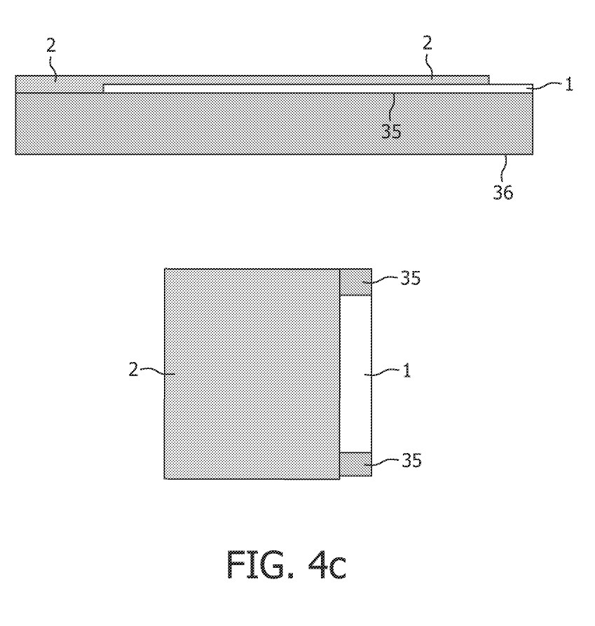

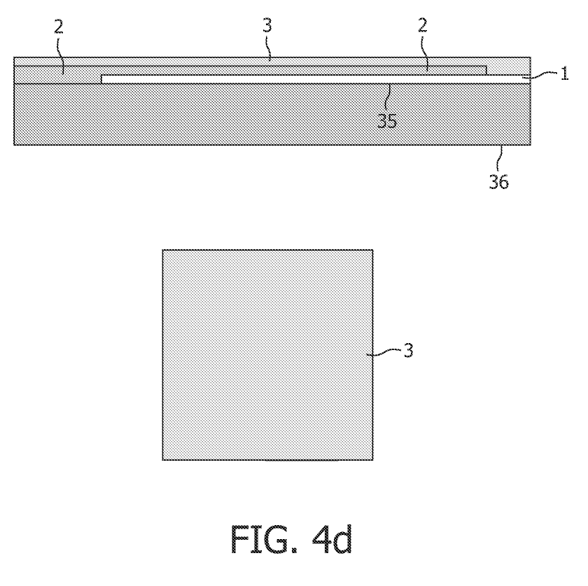

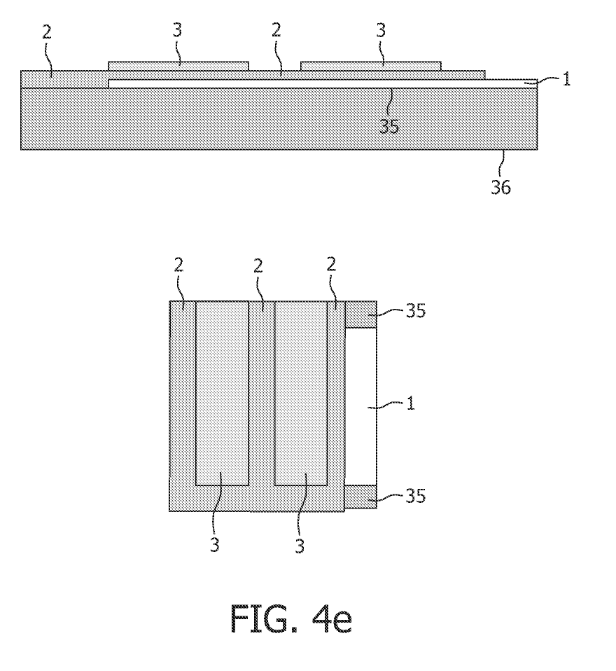

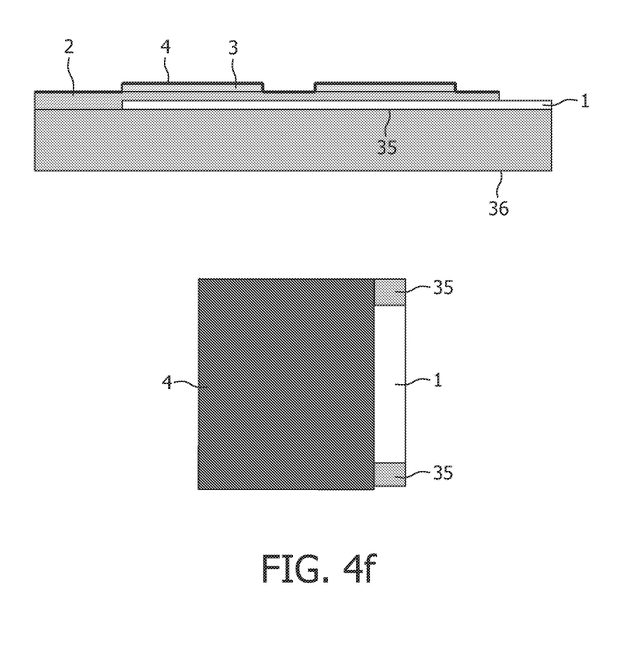

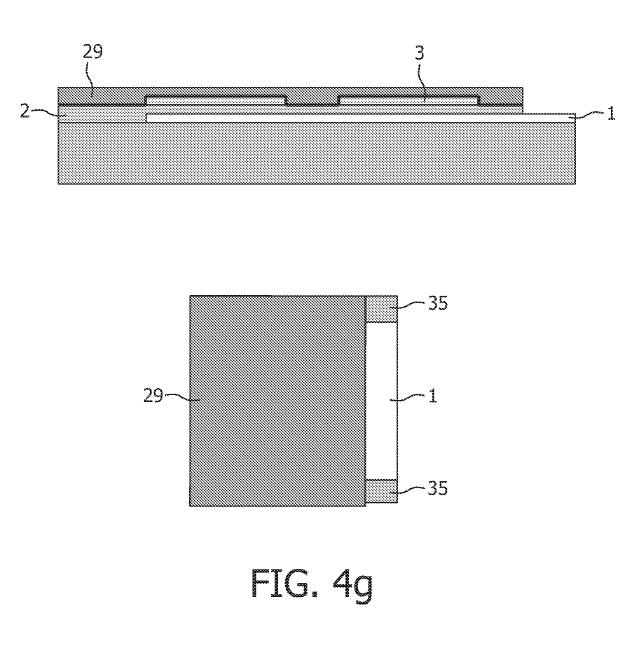

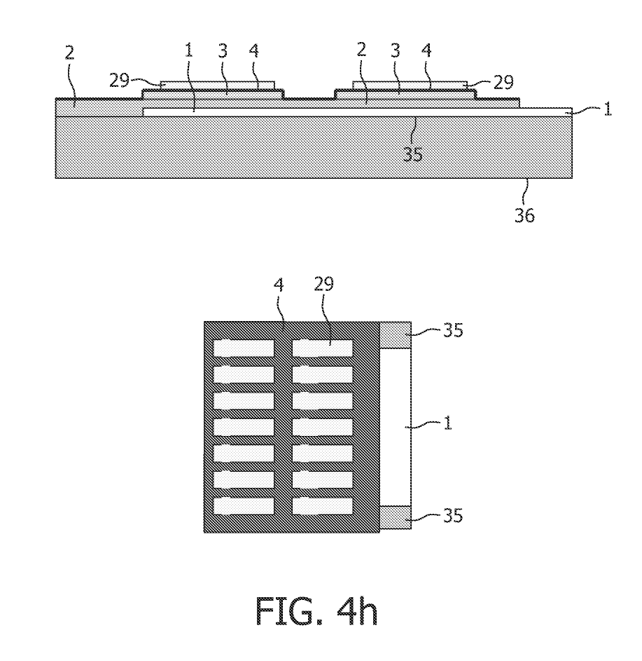

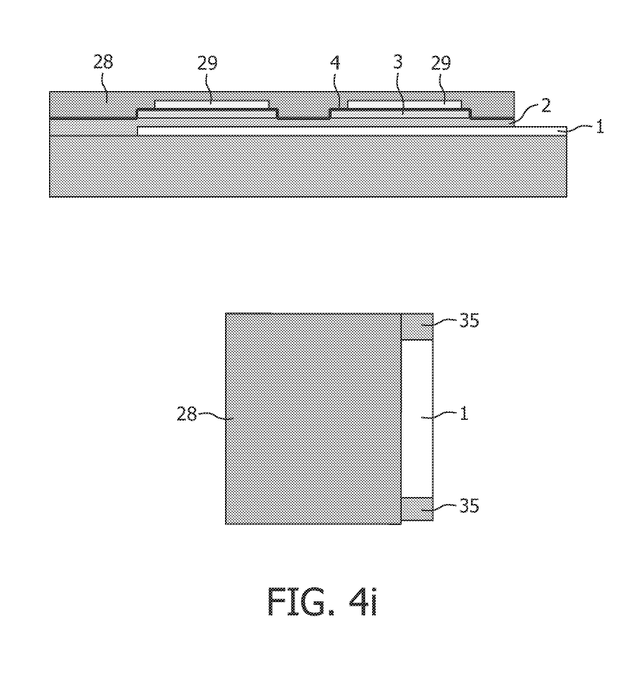

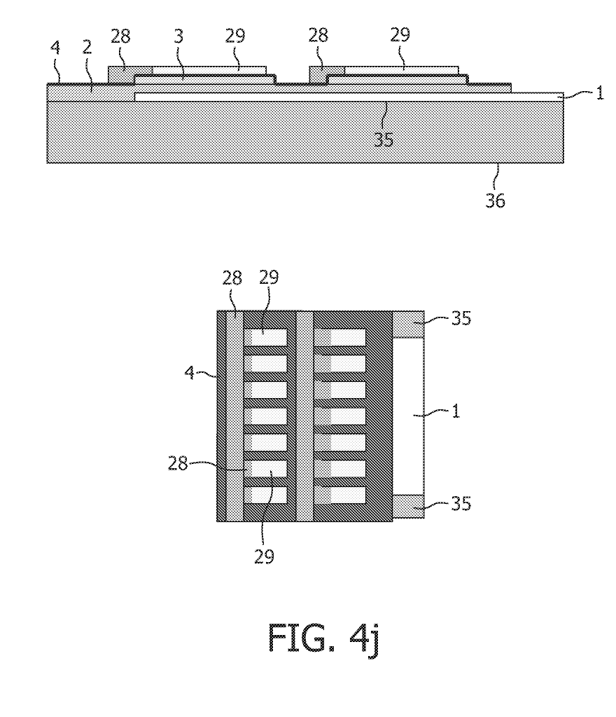

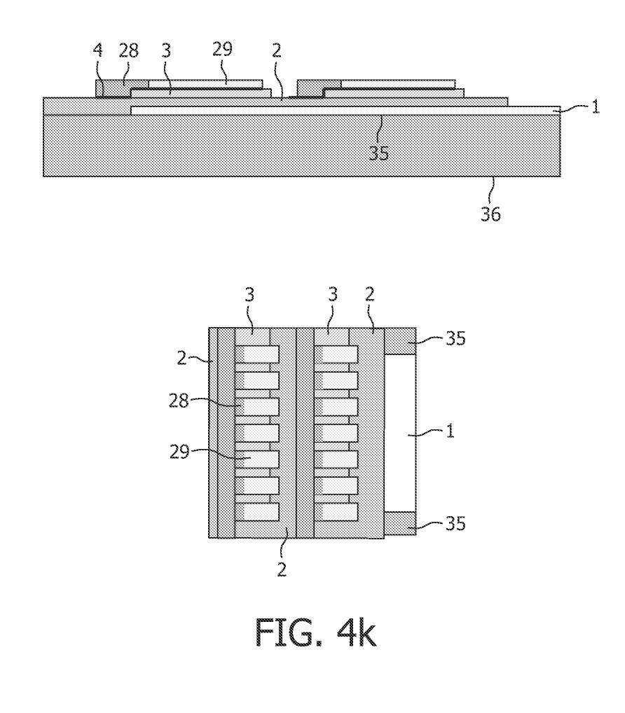

FIG. 4a to FIG. 4l demonstrate another method of how to form an actuator element 30 comprising a composite structure that is attached to a micro-channel 33. The figures shown at the bottom in FIG. 4a to FIG. 4l illustrate another view not drawn to scale.

In this case, conventional technologies for processing micro-systems are used. The key steps are shown in FIG. 4d to FIG. 4l. FIG. 4a shows depositing a thin film 1 on the inner side 35 of the wall 36 of a micro-channel 33. This film may be of ITO. This thin film is structured by etching as shown in FIG. 4b. A dielectric layer 2 may be deposited on the thin film 1 as shown in FIG. 4c. A sacrificial layer 3 may be deposited on the dielectric layer 2 as shown in FIG. 4d. The sacrificial layer 3 may be composed of a metal (e.g aluminium), an oxide (e.g. SiOx), a nitride (e.g. SixNy) or a polymer. The material that the sacrificial layer 3 is composed of, should be such that it can be selectively etched with respect to the material the actuator element 30 is formed of. It may be deposited on the dielectric layer 2 over a suitable length. In some embodiments the sacrificial layer 3 may be deposited over the whole dielectric layer 2 typically in the order of several cm. However, in other embodiments, the sacrificial layer 3 may be deposited over a length L, which may be the same length as the length of the actuator element 30, which may typically be between 10 to 100 μm. Depending on the material used, the sacrificial layer 3 may have a thickness of between 0.1 and 10 μm. The sacrificial layer 3 is etched in a desired pattern using lithography as shown in FIG. 4e. As an optional step, a magnetic layer 4 may be deposited on the sacrificial layer 3 as shown in FIG. 4f. The magnetic layer 4 may be NiFe or a Cobalt based alloy or any other magnetic material. The polymer layer that forms the second part 29 of the composite structure is then deposited by spin-coating on the magnetic layer 4 as shown in FIG. 4g. The polymer layer may be made of a material (e.g. poly-imide, poly-acrylamide and the like) in which magnetic particles are dispersed. The polymer layer 29 is patterned and cured using conventional lithography (which is a one-step process if the polymer material is photosensitive) as shown in FIG. 4h. The low-modulus polymer layer or the compliant polymer layer that forms the first part 28 of the composite structure is then deposited by spin-coating as shown in FIG. 4i and patterned into the desired geometry using conventional lithography as shown in FIG. 4j. The magnetic layer 4, if present, is subsequently etched at the uncovered areas as shown in FIG. 4k. The last step consists of etching away the sacrificial layer 3 from underneath the actuator structures as shown in FIG. 4l. Thus the polymer layer 28 is released from the inner side 35 of the wall 36 over the length L, this part forming the polymer MEMS 31 with the composite structure. The part of the low-modulus polymer layer 28 that stays attached to the inner side 35 of the wall 36 forms the attachment means 32 for attaching the polymer MEMS to the micro-channel 33, more particularly to the inner side 35 of the wall 36 of the micro-channel 33. Depending on their composition and the processing conditions, they will be either straight or curved as shown in FIG. 4l due to an internal stress distribution.

Another way to form the actuator element 30 according to the present invention may be by using patterned surface energy engineering of the inner side 35 of the wall 36 before applying the polymer material. In that case, the inner side 35 of the wall 36 of the micro-channel 33 to which the actuator elements 30 will be attached is patterned in such a way that regions with different surface energies are obtained. This can be done with suitable techniques such as lithography or printing. Therefore, the layer of material, from which the actuator elements 30 will be constructed, is deposited and structured with suitable techniques known by a person skilled in the art. The layer will attach strongly to some areas of the inner side 35 of the wall 36 underneath, further referred to as strong adhesion areas, and weakly to other areas of the inner side 35 of the wall 36, further referred to as weak adhesion areas. It may then be possible to get spontaneous release of the layer in the weak adhesion areas, whereas the layer will remain fixed in the strong adhesion areas. The strong adhesion areas may then form the attachment means 32. In that way it is thus possible to obtain self-forming free-standing actuator elements 30.

Preferably, the polymers the polymer MEMS 31 are formed of should be biocompatible polymers such that they have minimal (bio)chemical interactions with the fluid in the micro-channels 33 or the components of the fluid in the micro-channels 33. Alternatively, the actuator elements 30 may be modified so as to control non-specific adsorption properties and wettability. It could also be mentioned that “liquid crystal polymer network materials” may be used in accordance with the present invention.

In a non-actuated state, i.e. when no external stimuli are applied to the actuator element 30, the polymer MEMS 31 which, in a specific example, may have the form of a beam, are either curved or straight. An external stimulus, such as an electric field (current) or an electromagnetic radiation (light) or a magnetic field or any other suitable means applied to the polymer actuator elements 30, causes them to bend or straighten out or rotate or, in other words, causes them to be set in motion. The change in shape of the actuator elements 30 sets the surrounding fluid, which is present in the micro-channel 33 of the micro-fluidic system, in motion.

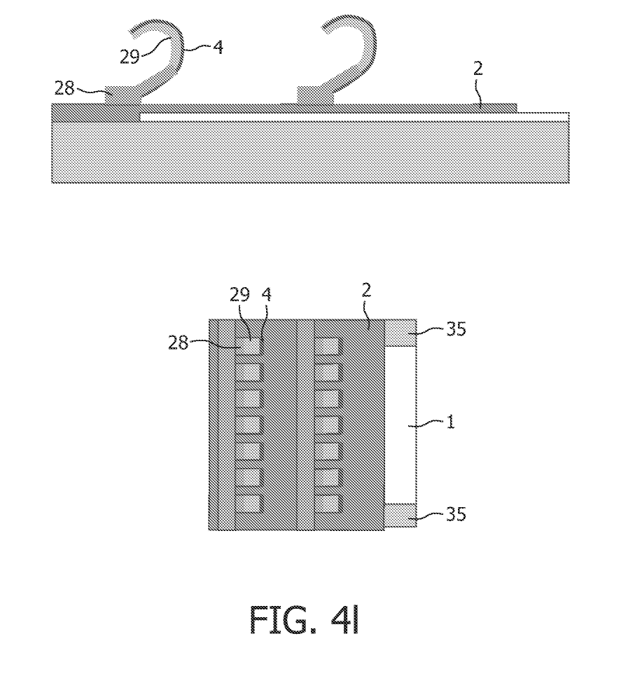

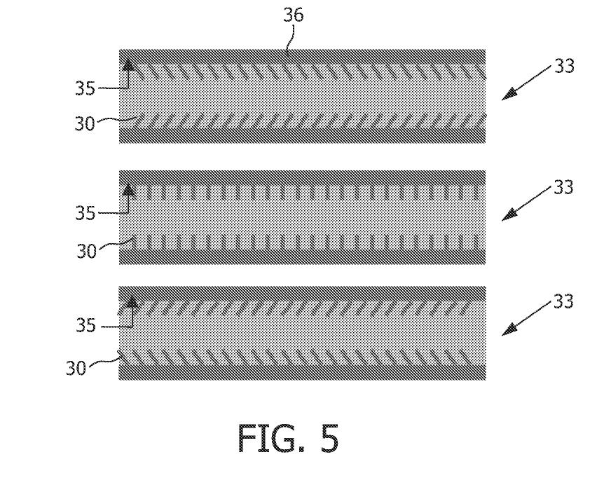

FIG. 5 illustrates an embodiment of a micro-channel 33 provided with actuator elements according to the present invention. In this embodiment, an example of a design of a micro-fluidic system (excluding means for applying stimuli) is shown. A cross-section of a micro-channel 33 is schematically depicted. According to this embodiment of the invention, the inner sides 35 of the walls 36 of the micro-channels 33 may be covered with a plurality of straight polymer actuator elements 30. For the clarity of the drawings, only the polymer MEMS part 31 of the actuator element 30 is shown. The composite structure of the actuator elements is not shown in the figure. The polymer MEMS 31 can move back and forth, under the action of an external stimulus applied to the actuator elements 30. This external stimulus may be an electric field, electromagnetic radiation, a magnetic field, or other suitable means. The actuator elements 30 may comprise polymer MEMS 31 which may e.g. have a rod-like shape or a beam-like shape, with their width extending in a direction coming out of the plane of the drawing.

The actuator elements 30 on the inner side 35 of the walls 36 of the micro-channels 33 may, in embodiments of the invention, be arranged in one or more rows. As an example only, the actuator elements 30 may be arranged in two rows of actuator elements 30, i.e. a first row of actuator elements 30 on a first position on the inner side 35 of the wall 36 and a second row of actuator elements 30 on a second position of the inner side 35 of the wall 36, the first and second positions being substantially opposite to each other. In other embodiments of the present invention, the actuator elements 31 may also be arranged in a plurality of rows of actuator elements 30 which may be arranged to form a two-dimensional array. In still further embodiments, the actuator elements 30 may be randomly positioned on the inner side 35 of the wall 36 of a micro-channel 33.

To be able to transport a fluid in a certain direction, for example from the left to the right in FIG. 5, the movement of the actuator elements 30 must be asymmetric. For a pumping device the motion of the polymer actuator elements is provided by a metachronic actuator means. This can be done by providing means for addressing the actuator elements 30 either individually or row by row. In case of electrostatic actuation this may be achieved by a patterned electrode structure that is part of a wall 36 of a micro-channel 33. The patterned electrode structure may comprise a structured film, which may be a metal or another suitable conductive film. Structuring of the film may be done by lithography. The patterned structures can be individually addressed. The same may be applied for magnetically actuated structures. Patterned conductive films that are part of the channel wall structure may make it possible to create local magnetic fields so that actuator elements 30 can be addressed individually or in rows.

In all cases described above, individual or row-by-row stimulation of the actuator elements 30 is possible since the wall 36 of the micro-channel 33 comprises a structured pattern through which the stimulus is activated. A co-ordinated stimulation, in a wave-like manner, is made possible by proper addressing in time. Non-co-ordinated or random actuator means, symplectic metachronic actuator means and antiplectic metachronic actuator means are included within the scope of the present invention.

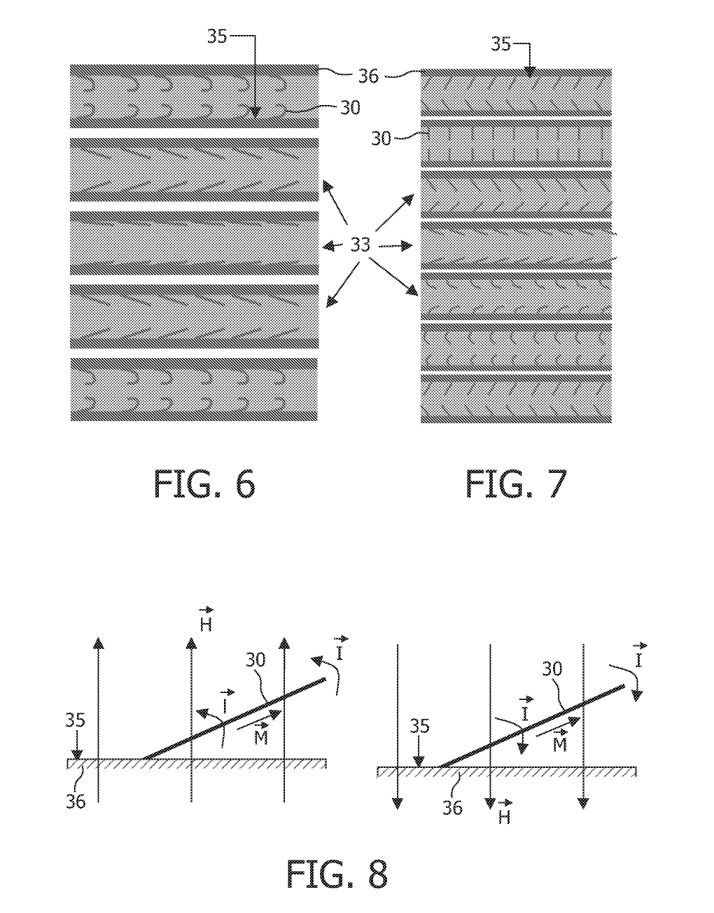

In the example shown in FIG. 5, all actuator elements 30, also those on different rows, move simultaneously. The functioning of the polymer actuators 30 may be improved by individual addressing of the actuator elements 30 or of the rows of actuator elements 30, so that their movement is out of phase. In electrically stimulated actuator elements 30, this may be performed by using patterned electrodes which may be integrated into the walls 36 of the micro-channel 33 (not shown in the drawing). Thus, the motion of actuator elements 30 appears as a wave passing over the inner side 35 of the wall 36 of the micro-channel 33, similar to the wave movement illustrated in FIG. 6. The means for providing the movement may generate a wave movement that may pass in the same direction as the effective beating movement (“symplectic metachronism”) or in the opposite direction (“antiplectic metachronism”).

To obtain local mixing in a micro-channel 33 of a micro-fluidic system, the motion of the actuator elements 30 may be deliberately made uncorrelated, i.e. some actuator elements 30 may move in one direction, whereas other actuator elements 30 may move in the opposite direction in a specific way so as to create local chaotic mixing. Vortices may be created by opposite movements of the actuator elements 30 on opposite positions of the walls 36 of the micro-channel 33.

A further embodiment of a micro-fluidic channel 33 provided with actuator elements 30 according to the present invention is schematically illustrated in FIG. 6. The inner side 35 of the walls 36 of the micro-channels 33 may, in this embodiment, be covered with actuator elements 30 that can be changed from a curled shape into a straight shape. This change of shape can be obtained in different ways. For example, a change of shape of the actuator element 30 can be obtained by controlling the microstructure of the actuator element 30, by introducing a gradient in effective material stiffness over the thickness of the actuator element 30, wherein the top of the actuator elements is stiffer than the bottom. This can also be achieved by the composite structure of the actuator elements. This will cause “asymmetric bending”, i.e. the actuator element 30 will bend more easily one way than the other. Change of shape of the actuator element 30 may also be achieved by controlling the driving of the stimulus, such as a time- and/or space-dependent magnetic field in case of magnetic actuation. In this embodiment, an asymmetric movement of the actuator elements 30 may be obtained, which may be further enhanced by moving fast in one direction and slowly in the other, e.g. a fast movement from the curled to the straight shaped and a slow movement from the straight to the curled shape, or vice versa. The polymer actuator elements 30 adapted for changing shape may comprise polymer MEMS 31 with e.g. a rod-like shape or with a beam-like shape. The actuator elements 30 may, according to embodiments of the invention, be arranged in one or more rows, e.g. a first and a second row on the inner side 35 of the wall 36 of the micro-channel 33, the first and second row being positioned at substantially opposite positions on the inner side 35 of the wall 36. In other embodiments of the invention, the actuator elements 30 may be positioned in a plurality of rows of actuator elements 30 which may be arranged to form, for example, a two-dimensional array. In still further embodiments of the invention, the actuator elements 30 may be randomly arranged on the inner side 35 of the wall 36 of a micro-channel 36. By individually addressing the actuator elements 30 or a row of actuator elements 30, a wave-like movement, an otherwise correlated movement, or an uncorrelated movement may be generated that can be advantageous in transporting or mixing fluids, or creating vortices, all inside the micro-channel 33.

A further embodiment of the present invention is illustrated in FIG. 7. The inner side 35 of the walls 36 of the micro-channel 33 may, in this embodiment, be covered with actuator elements 30 that undertake an asymmetric movement. This may be achieved by inducing a change of molecular order in the actuator elements 30 from one side to the other. In other words, a gradient in material structure over the thickness ‘t’ of the actuator elements 30 is obtained. This gradient may be achieved in various ways. In case of liquid crystal polymer networks, the orientation of the liquid crystal molecules can be varied from top to bottom of the layers by controlled processing, for example by using a process which is used for amongst others, liquid crystal (LC) display processing. Another possible way to achieve such a gradient is by building or depositing the layer the actuator element 30 is formed of with different materials of varying stiffness.

The asymmetric movement may be further enhanced by moving fast in one direction and slowly in the other. The actuator elements 30 may comprise polymer MEMS 31 with an elongated shape such as a rod-like shape or a beam-like shape. The actuator elements 30 may, in embodiments of the invention, be arranged on the inner side 35 of the walls 36 in one or more rows, e.g. in a first and a second row, for example one row of actuator elements 30 on each of two substantially opposite positions on the inner side 35 of the wall 36. In other embodiments of the present invention, a plurality of rows of actuator elements 30 may be arranged to form a two-dimensional array. In still further embodiments, the actuator elements 30 may be randomly arranged on the inner side 35 of the wall 36 of a micro-channel 33. By individual addressing of the actuator elements 30 or by individual addressing of rows of actuator elements 30, a wave-like movement, an otherwise correlated movement, or an uncorrelated movement may be generated that can be advantageous in transporting and mixing of fluid, or in creating vortices.

In FIG. 5 to FIG. 7, three examples of possible designs of micro-fluidic systems according to embodiments of the present invention are shown, which illustrate embodiments using actuator elements 30 integrated on the inner side 35 of the walls 36 of micro-channels 33 to manipulate fluid in micro-channels 33. It should, however, be understood by a person skilled in the art that other designs are conceivable and that the specific embodiments described are not limiting to the invention.

An advantage of the approach according to the present invention is that the means which takes care of fluid manipulation is completely integrated into the micro-fluidic system. This allows large shape changes that are required for micro-fluidic applications, without the need for any external pump or micro-pump. Hence, the present invention provides compact micro-fluidic systems. Another, perhaps even more important advantage, is that the fluid can be controlled locally in the micro-channels 33 by addressing all actuator elements 30 at the same time or by addressing only one predetermined actuator element 30 at a time. Therefore, the fluid can be transported, re-circulated, mixed, or separated right at a required and at a predetermined position. A further advantage of the present invention is that the use of polymers for the actuator elements 30 may lead to cheap processing technologies such as, for example, printing or embossing techniques, or single-step lithography.

Furthermore, the micro-fluidic system according to the present invention is robust. The performance of the overall micro-fluidic system is not largely disturbed, if a single or a few actuator elements 30 fail to work properly.

The micro-fluidic systems according to the invention may be used in biotechnological applications such as biosensors, rapid DNA separation and sizing, cell manipulation and sorting, in pharmaceutical applications, in high-throughput combinatorial testing where local mixing is essential and in micro-channel cooling systems in microelectronics applications.

The micro-fluidic system of the present invention may be used in biosensors for the detection of at least one target molecule, such as proteins, antibodies, nucleic acids (e.g. DNA, RNA), peptides, oligo- or polysaccharides or sugars and the like in biological fluids, such as saliva, sputum, blood, blood plasma, interstitial fluid or urine. Therefore, a small sample of the fluid (e.g. a droplet) is supplied to the device, and by manipulation of the fluid within a micro-channel system, the fluid is let to the sensing position where the actual detection takes place. By using various sensors in the micro-fluidic system according to the present invention, different types of target molecules may be detected in one analysis run.

The application of a magnetic field to the magnetic actuator elements 30 may result in translational as well as rotational forces to the actuator elements 30. The rotational force, i.e. the torque on the magnetic actuator element 30, will cause it to move, i.e. to rotate, and/or to change shape. This is illustrated in FIG. 8 for a static, uniform magnetic field applied to the magnetic actuator elements 30 by an external magnetic field generating means. This magnetic field generating means can be an electromagnet, a permanent magnet adjacent to the micro-fluidic system, or an internal magnetic field generating means such as conductive lines integrated in the micro-fluidic system.

In the situation sketched in FIG. 8, the approach of the completely erected state will go slower and slower as the angle between the magnetic moment \vec{M} and the magnetic field \vec{H} decreases. This may be solved by rotating the magnetic field during the movement of the actuator element 30.

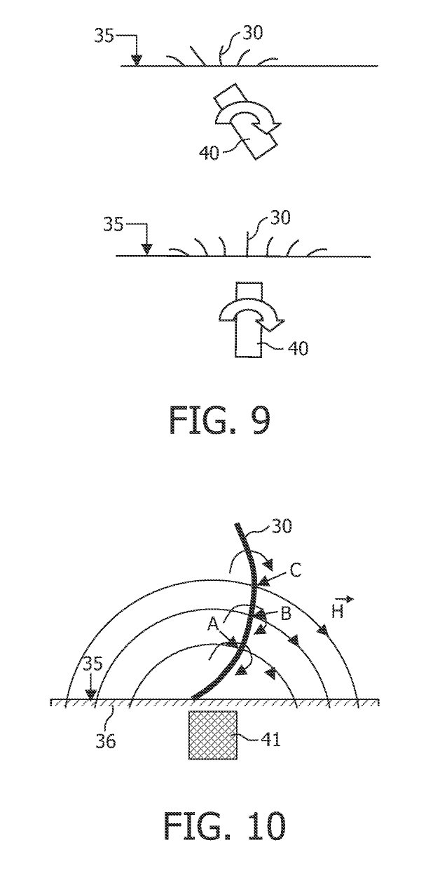

A rotating field applied by a rotating permanent magnet 40, may generate a rotational motion of individual actuator elements 30 and a concerted rolling motion of an array (or a wave) of magnetic actuator elements 30, as schematically illustrated in FIG. 9. In case of magnetic actuator elements 30 with a permanent magnetic moment, the recovery stroke will occur with actuator element forces oriented towards the surface, so with the actuator elements 30 sliding over the surface rather than through the bulk of the fluid in the micro-channel 33.

To be able to transport fluid through a micro-channel 33 by the movement of the actuator elements 30 positioned on the inner side 35 of the wall 36 of the micro-channel 33, a certain force and/or magnetic moment is required to be applied to the surrounding fluid in the micro-channel 33. Instead of using an external magnetic field generating means such as a permanent magnet or an electromagnet that can be placed outside the micro-fluidic system as described above, another possibility is to use conductive lines 41 that may be integrated in the micro-fluidic system. This is illustrated in FIG. 10. The conductive lines 41 may be copper lines with a cross-sectional area of about 1 to 100 μm². The magnetic field generated by a current through the conductive line 41 decreases with 1/r, r being the distance from the conductive line 41 to a position on the actuator element 30. For example, in FIG. 10, the magnetic field will be larger at position A than at position B of the actuator element 30. Similarly, the magnetic field at position B will be larger than the magnetic field at position C of the actuator element 10. Therefore, the polymer actuator element 30 will experience a gradient in magnetic field along its length L. This will cause a “curling” motion of the magnetic actuator element 30, on top of its rotational motion. It can thus be imagined that, by combining a uniform magnetic “far field”, i.e. an externally generated magnetic field which is constant over the whole actuator element 30, the far field being either rotating or non-rotating, with conductive lines 41, it may be possible to create complex time-dependent magnetic fields that enable complex moving shapes of the actuator element 30. This may be very convenient, in particular for tuning the moving shape of the actuator elements 30 so as to get an optimised efficiency and effectiveness in fluid control. A simple example may be that it would enable a tunable asymmetric movement, i.e. the “beating stroke” of the actuator element 30 to be different from the “recovery stroke” of the actuator element 30.

The movement of the actuator elements 30 may be measured by one or more magnetic sensors positioned in the micro-fluidic system. This may allow determining flow properties such as speed and/or viscosity of the fluid in the micro-channel 33. Furthermore, other details such as the cell content of the fluid (the hematocriet value), or the coagulation properties of the fluid may be measured by using different actuation frequencies.

An advantage of the above embodiment is that the use of magnetic actuation may work with very complex biological fluids such as e.g. saliva, sputum or full blood. Furthermore, magnetic actuation does not require contacts. In other words, magnetic actuation may be performed in a contactless way. When external magnetic field generating means are used, the actuator elements 30 are inside the micro-fluidic cartridge while the external magnetic field generating means are positioned outside the micro-fluidic cartridge.

It is to be understood that although preferred embodiments, specific constructions and configurations, as well as materials, have been discussed herein for devices according to the present invention, various changes or modifications in form and detail may be made without departing from the scope and spirit of this invention. For example, the change in shape and/or orientation of the actuator elements 30 may lead to a distributed drive of liquid present in the micro-channels 33 of a micro-fluidic system. This could then be modified to be used as a pump. Sequential addressing of actuator elements 30 by means of external stimuli could cause a wave ripple for driving a liquid in one direction in the micro-channel 33. The external stimuli may be an electrical field generating means. In that case one or more electrodes, e.g. conducting poly pyrrole electrodes, can be incorporated in the actuator elements 30. By sequentially addressing the one or more electrodes in the actuator elements 30, the actuator elements 30 can sequentially change their shape and/or orientation. This causes a wave ripple.

1. A micro-fluidic system comprising at least one micro-channel (33) having a wall (36) with an inner side (35), wherein said micro-fluidic system furthermore comprises:
a plurality of actuator elements (30) attached to said inner side (35) of said wall (36), each actuator element (30) having a shape, an orientation and a composite structure; and
means for applying stimuli to said plurality of actuator elements (30) so as to cause a change in their shape and/or orientation.

2. A micro-fluidic system of claim 1, wherein said composite structure includes at least a first part (28) and at least a second part (29) wherein said first part (28) has an elastic modulus that is at least a hundred times lower than the elastic modulus of said second part (29).

3. A micro-fluidic system of claim 2, wherein said first part (28) has an elastic modulus in the range of about 1 kPa-100 MPa.

4. A micro-fluidic system of claim 2, wherein said second part (29) has an elastic modulus in the range of about 1 GPa-200 GPa.

5. A micro-fluidic system of claim 2, wherein said first part (28) is attached to said inner side (35) of said wall (36).

6. A micro-fluidic system according to claim 2,
wherein said first part (28) comprises an elastomer or a polymer gel.

7. A micro-fluidic system according to claim 2, wherein said second part (29) comprises material selected from the group consisting of: a polymer based material, of a metal, a magnetic monolithic material and a composite material.

8. (canceled)

9. A micro-fluidic system according to claim 1, wherein said means for applying a stimulus to said plurality of actuator elements (30) is selected from the group consisting of an electric field generating means, an electromagnetic field generating means, an electromagnetic radiation means, a magnetic field generating means.

10. A micro-fluidic system according to claim 9, wherein said means for applying a stimulus to said actuator elements (30) is a magnetic field generating means.

11. A micro-fluidic system according to claim 1, wherein said plurality of actuator elements (30) are arranged in a first and a second row, said first row of actuator elements being positioned at a first position of said inner side (35) of said wall (36) and said second row of actuator elements (30) being positioned at a second position of said inner side (35) of said wall (36), said first position and said second position being substantially opposite to each other.

12. A micro-fluidic system according to claim 1, wherein said plurality of actuator elements (30) are arranged in a plurality of rows of actuator elements (30) which are arranged to form a two-dimensional array.

13. A micro-fluidic system according to claim 1, wherein said plurality of actuator elements (30) is randomly arranged on the inner side (35) of said wall (36).

14. A method of manufacturing a micro-fluidic system comprising at least one micro-channel (33), the method comprising:
providing an inner side (35) of a wall (36) of said at least one micro-channel (33) with a plurality of actuator elements (30) with a composite structure; and
providing means for applying a stimulus to said plurality of actuator elements (30).

15. A method according to claim 14, wherein providing said plurality of actuator elements (30) with said composite structure is performed by: spin-coating a low-modulus polymer having a length Li on said inner side (35) of said wall (36) to form said first part (28) of said composite structure;
spin-coating a magnetic polymer-based material having a length of L2 on top of said low-modulus polymer to form said second part (29) of said composite structure; and
structuring said coatings by ion beam lithography to form said composite structure.

16. A method according to claim 14, wherein providing said plurality of actuator elements (30) with composite structure is performed by:
depositing and patterning a sacrificial layer (3) on said inner side (35) of said wall (35);
spin-coating and structuring a magnetic polymer-based material to form said second part (29) of said composite structure;
spin-coating and structuring a low-modulus polymer material to form said first part (28) of said composite structure; and
removing said sacrificial layer (3) by etching to form said composite structure.

17. A method according to claim 14, wherein providing said plurality of actuator elements (30) with composite structure is performed by:
surface energy patterning of said inner side (35) of said wall (36);
spin-coating and structuring a magnetic polymer-based material to form said second part (29) of said composite structure;
spin-coating and structuring a low-modulus polymer material to form said first part (28) of said composite structure; and
applying a driving force to partially release the polymer materials from said inner side (35) of said wall (36) to form said composite structure

18. A method according to claim 14, furthermore comprising providing said second part (29) of said composite structure with a uniform continuous magnetic layer, or a patterned continuous magnetic layer, or with magnetic particles.

19. A method according to claim 14, wherein providing means for applying a stimulus to said actuator elements (30) comprises providing a magnetic or an electric field generating means.

20. (canceled)

21. A method of controlling a fluid flow through a micro-channel (33) of a micro-fluidic system, the micro-channel (33) having a wall (36) with an inner side (35), the method comprising:
providing said inner side (35) of said wall (36) with a plurality of actuator elements (30), said actuator elements (30) each having a shape, an orientation and a composite structure; and
applying a stimulus to said actuator elements (30) so as to cause a change in its shape and/or orientation.

22. A method according to claim 22, wherein applying said stimulus to said actuator elements (30) is performed by applying a magnetic field.

23. (canceled)

24. (canceled)
